(19) United States
(12) Patent Application Publication
(10) Pub. No.: US 2025/0308872 A1
(43) Pub. Date: Oct. 2, 2025

(54) HIGH-THROUGHPUT MASS SPECTROMETRY IMAGING WITH DYNAMIC SPARSE SAMPLING

(71) Applicants: Purdue Research Foundation, West Lafayette, IN (US); MARQUETTE UNIVERSITY, Milwaukee, WI (US)

(72) Inventors: David S HELMINIAK, Milwaukee, WI (US); Hang HU, Clark, NJ (US); Julia LASKIN, Lafayette, IN (US); Dong Hye YE, Milwaukee, WI (US)

(73) Assignees: Purdue Research Foundation, West Lafayette, IN (US); MARQUETTE UNIVERSITY, Milwaukee, WI (US)

(21) Appl. No.: 18/864,523

(22) PCT Filed: Jun. 3, 2023
(86) PCT No.: PCT/US23/24383

§ 371 Date: Nov. 9, 2024

Related U.S. Application Data
(60) Provisional application No. 63/350,104, filed on Jun. 8, 2022.

(51) Int. Cl. H01J 49/00

(52) U.S. Cl. CPC H01J 49/0036; H01J 49/0004; H01J 49/0031

(57) ABSTRACT

A method of determining the next location for obtaining Mass Spectrometry Imaging (MSI) data is disclosed which includes receiving a priori MSI data for a plurality of m/z channels from all of a sample based on a predefined spatial resolution, choosing a first selection of m/z channels, iteratively receiving Estimated Reduction in Distortion (ERD) maps from a model for each of the first selection of m/z channels, indicating the next location where the MSI data is to be collected, identifying a plurality of operational sparse spatial locations on the sample, obtaining from the a priori MSI data, data associated with the first selection of m/z channels, reconstructing an operational MSI image from the spatially sparse data for selected m/z channels representing an operational reconstructed image from all of the sample, the model configured to output ERD maps for each of the first selection of m/z channels.

### CROSS-REFERENCE TO RELATED APPLICATIONS

The present non-provisional patent application is related to and claims the priority benefit of U.S. Provisional Patent Application Ser. No. 63/350,104, entitled HIGH-THROUGHPUT MASS SPECTROMETRY IMAGING WITH DYNAMIC SPARSE SAMPLING which was filed June 8. 2022, the contents of which are hereby incorporated by reference in its entirety into the present disclosure.

### STATEMENT REGARDING GOVERNMENT FUNDING

This invention was made with government support under HL145593 and CA255132 awarded by the National Institutes of Health. The government has certain rights in the invention.

### TECHNICAL FIELD

The present disclosure generally relates to mass spectrometry, and in particular, to a system and methods for detecting and quantifying target molecules in a sample using mass spectrometry imaging.

### BACKGROUND

This section introduces aspects that may help facilitate a better understanding of the disclosure. Accordingly, these statements are to be read in this light and are not to be understood as admissions about what is or is not prior art.

Mass Spectrometry Imaging (MSI) is a label-free molecular imaging technique, which enables mapping of multiple ions/molecules/atoms in biological tissues and/or chemical samples. MSI acquires mass spectra from distinct locations on the sample, that include signals of molecular ions detected for a range of mass-to-charge (m/z) ratios. The specific range of m/z values for which mass spectra are acquired and mass resolution depend on the physical hardware used in any given MSI experiment. Mass spectra across all spatial locations within an acquired sample may be segmented and/or combined into image channel arrays for visualizable spatial representations for m/z. This process is analogous to common image representations, such as RGB. In contrast with an RGB image, which may be broken down into individual red, green, and blue channels, with each comprising the spatial distribution of intensity values for different wavelengths of light, MSI generates hundreds of channels in each experiment. A visualized m/z channel comprises the spatial distribution of the signal for a given m/z across the sample. Each spatial location value within the image is a summation result—although other methods for combination, such as weighted averaging, may be used—of signal intensities within a 20 ppm (parts per million) spectral window (window size is dependent on experimental specificity requirements and MSI hardware capabilities) about the visualized central m/z value.

Examples of MSI hardware technologies include Matrix-Assisted Laser Desorption Ionization (MALDI), Secondary Ion Mass Spectroscopy (SIMS), and Desorption Electrospray Ionization (DESI). Each of these technologies use alternate methods (e.g., laser beam, cluster beam, or a stream of charged liquid microdroplets to desorb and ionize analytes), to separate material from a sample for analysis in a mass spectrometer. These experiments are often combined with additional biological or chemical analyses.

One common type of mass spectrometer for MALDI MSI are TOF (Time-of-Flight) type devices. During the ionization phase of MALDI, a laser illuminates a tissue of interest, causing vaporization. Ions generated in this process are introduced into a mass spectrometer under the influence of an electric field and gas flow, as known to a person having ordinary skill in the art. In TOF, the signal is measured from when ions enter the flight tube to when they reach a detector. The TOF for each ion is used to determine its m/z value.

Four decades of developing MSI sampling and acquisition, has enabled imaging of hundreds of molecules/ions/atoms at a cellular scale, with high sensitivity and specificity. Common development paths in this field focus on enhancing spatial resolution, throughput, and molecular coverage. For example, with a specially focused laser beam and post-ionization, the spatial resolution for a measured location has been reduced to about 1 μm. Meanwhile, the spatial resolution of liquid extraction-based imaging has improved from about 100 μm to better than 10 μm.

Several strategies have been used to improve molecular coverage. For example, ion mobility spectrometry has been coupled with MSI to separate ions based on their structures and charge states, which increases the depth of coverage and enables the differentiation of isobaric ions in the gas phase. In addition, isomer-selective imaging of unsaturated lipids has been achieved by combining chemical derivatization with tandem Mass Spectrometry (MS) of the products. Although these developments bring significant advantages, they usually trade off costs in imaging time by sampling more locations or acquiring for a longer time at each position.

However, relatively low experimental throughput of MSI is a major obstacle for several important applications. For example, MSI may replace the traditional Hematoxylin & Eosin (H&E) microscopy in intraoperative tissue analysis, but would require experimental completion and a resulting analysis in less than 30 minutes. Three-Dimensional (3D) MSI is another application limited by the experimental throughput. 3D ion images create depictions of molecular distributions in physical volumes, which can be used to interpret complex interrelationships of anatomical structures. 3D MSI is usually performed through serial sectioning of a tissue followed by 2D imaging of the individual sections. The 2D images are co-registered to construct 3D MSI images. Since 3D imaging experiments require dozens of sections for the same tissue, this can only become practical with high-throughput capabilities.

Several strategies have been developed to improve the throughput of MSI. MALDI uses a Nd: YLF solid state laser with high repetition rate to analyze tissue sections using a continuous raster scan, achieving an MSI acquisition rate of 50 locations/s. A TOF-MALDI instrument equipped with a galvanometer-based optical scanner has been used to achieve the acquisition rate of 100 locations/s in a laser scanning mode. However, acquiring more data generally corresponds to additional processing requirements. If the purpose of an experiment was known in prior, less information was likely needed to realize the original objectives than normally would be obtained.

In Fourier Transform Ion Cyclotron Resonance (FT-ICR) MSI, a parallel ion accumulation and detection approach has been developed to significantly shorten data acquisition time. Further computational approaches have been developed to improve the throughput of MSI experiments. For example, a subspace modeling approach has been used to accelerate FT-ICR MSI by reconstructing high-resolution mass spectral data from short transients. A follow up study coupled a compressed sensing method with subspace modeling to reconstruct MSI images from sparse sampling of randomly selected locations. By reducing the total number of measurements to be performed in MSI experiment, the data acquisition time significantly decreases. These approaches attempt to reduce the total amount of information acquired to just that required for a known experimental objective. However, the use of random sampling and/or pre-designed acquisition patterns lacks flexibility to change in response to newly encountered information.

Therefore, there is an unmet need for a novel approach to improve throughput of MSI technologies by means of dynamic sampling.

### SUMMARY

A method of determining the next location for obtaining Mass Spectrometry Imaging (MSI) data from a sample using sparse data for a plurality of m/z channels is disclosed which includes receiving a priori MSI data for a plurality of m/z channels from all of a sample based on a predefined spatial resolution, each m/z channel corresponding to one or more predetermined chemical constituents in the sample, choosing a first selection of m/z channels of interest from the plurality of m/z channels, iteratively receiving Estimated Reduction in Distortion (ERD) maps (OPERATIONAL ERDᵢ) from a model for each of the first selection of m/z channels, indicating the next location where the MSI data is to be collected, identifying a plurality of operational sparse spatial locations on the sample (OPERATIONAL SPARSE SPATIAL LOCATIONS) based on the OPERATIONAL ERDᵢ, obtaining from the a priori MSI data, data associated with the first selection of m/z channels of interest for each of the OPERATIONAL SPARSE SPATIAL LOCATIONS (OPERATIONAL SPATIALLY SPARSE DATA FOR SELECTED M/Z CHANNELS), reconstructing an operational MSI image from the spatially sparse data for selected m/z channels representing an operational reconstructed image from all of the sample, and providing to the model i) the OPERATIONAL SPARSE SPATIAL LOCATIONS ii) the OPERATIONAL SPATIALLY SPARSE DATA FOR SELECTED M/Z CHANNELS, and ii) the reconstructed operational MSI image, the model configured to output ERD maps for each of the first selection of m/z channels, representing the next location where the MSI data is to be collected (OPERATIONAL ERDᵢ₊₁).

In said method, the step of identifying a plurality of operational sparse spatial locations is based on a first sparse location selection criterion.

In said method, the first sparse location selection criterion is based on a random selection.

In said method, the first sparse location selection criterion is based on a statistical selection criterion selected from the group consisting of weighted sampling based on richness of data associated with various geometric points of the sample, non-weighted sampling, a preselected pattern of sampling, or a combination thereof.

In said method, the step of reconstructing an operational MSI image is based on a first reconstruction approach.

In said method, the first reconstruction approach is based on a first non-learning interpolation approach.

In said method, the first non-learning interpolation approach is selected from the group consisting of fast marching, nearest neighbor, linear, bilinear, cubic convolution, kriging, radial basis, Inverse Distance Weighted (IDW) mean interpolation, or a combination thereof.

In said method, the first reconstruction approach is based on a first learning interpolation approach.

In said method, the first learning interpolation approach is selected from the group consisting of convolutional neural networks, generative adversarial networks, graph neural networks, or a combination thereof.

In said method, the model is a neural network.

In said method, the neural network is a convolutional neural network (CNN), having a plurality of layers including an input layer, one or more hidden layers, and an output layer, the plurality of layers connected to each other via weights. Training of the CNN includes choosing a second selection of m/z channels of interest from the plurality of m/z channels, for each of the second selection of m/z channels of interest, iteratively: parsing the a priori MSI data based on the second selection of m/z channels to obtain SELECTED M/Z MSI DATA, identifying a plurality of training sparse spatial locations on the sample (TRAINING SPARSE SPATIAL LOCATIONS), obtaining from the SELECTED M/Z MSI DATA, data associated with the TRAINING SPARSE SPATIAL LOCATIONS (TRAINING SPATIALLY SPARSE DATA FOR SELECTED M/Z CHANNELS), reconstructing training MSI images from the spatially sparse data for selected m/z channels representing a reconstructed image from all of the sample, providing to the model i) the TRAINING SPARSE SPATIAL LOCATIONS ii) the TRAINING SPATIALLY SPARSE DATA FOR SELECTED M/Z CHANNELS, and ii) the training reconstructed MSI image, the model configured to output training ERD maps (TRAINING ERDᵢ) for each of the second selection of m/z channels, iteratively establishing a model training error based on comparing the TRAINING ERDᵢ with an actual Reduction in Distortion (RDᵢ) representing a difference between the reconstructed training MSI image and the a priori MSI data, and minimizing the model training error by modifying the CNN weights.

In said method, the step of identifying a plurality of training sparse spatial locations is based on a second sparse location selection criterion.

In said method, the second sparse location selection criterion is based on a random selection.

In said method, the second sparse location selection criterion is based on a statistical selection criterion selected from the group consisting of weighted sampling based on richness of data associated with various geometric points of the sample, non-weighted sampling, a preselected pattern of sampling, or a combination thereof.

In said method, the second sparse location selection criterion is same as the first sparse location selection criterion.

In said method, the step of reconstructing a training MSI image is based on a second reconstruction approach.

In said method, the second reconstruction approach is same as the first reconstruction approach.

In said method, the second reconstruction approach is based on a second non-learning interpolation approach.

In said method, the second non-learning interpolation approach is same as the first non-learning interpolation approach.

In said method, the second non-learning interpolation approach is selected from the group consisting of fast marching, nearest neighbor, linear, bilinear, cubic convolution, kriging, radial basis, Inverse Distance Weighted (IDW) mean interpolation, or a combination thereof.

In said method, the second reconstruction approach is based on a second learning interpolation approach.

In said method, the second learning interpolation approach is same as the first learning interpolation approach.

In said method, the second learning interpolation approach is selected from the group consisting of convolutional neural networks, generative adversarial networks, graph neural networks, or a combination thereof.

In said method, the RDᵢ is based on a plurality of unmeasured locations wherein for each such location the difference between the reconstructed training MSI image and the a priori MSI data is applied upon by a Gaussian filter and summed.

In said method, the second selection of m/z channels of interest is same as the first selection of m/z channels of interest.

### BRIEF DESCRIPTION OF DRAWINGS

FIGS. 1 and 2 are schematics depicting a training flow for a model used in the methodology of the present disclosure, at least according to one embodiment.

FIGS. 3 and 4 are schematics depicting an operational flow for the method of the present disclosure, at least according to one embodiment.

### DETAILED DESCRIPTION

For the purposes of promoting an understanding of the principles in the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

In the present disclosure, “desirable information” or “desirable data” may refer to a set of experimental objectives and/or measurable values that may relate to data obtainable by MSI technologies. These objectives and/or values are not limited to their intrinsic worth, nor of a single experiment or sample, but extends to values and/or objectives that may be derived, estimated, or correlated with such.

In the present disclosure, limitations, approximations, and methods are described for currently realizable implementation(s) of dynamic sampling for MSI technologies. This is intended to demonstrate practical considerations for the employment of the described invention and an example of how it may be applied in actuality. It should be understood that no limitation of the scope of this disclosure is thereby intended.

A novel approach is described herein to improve throughput of MSI technologies, based on dynamic sampling. During MSI experiments, large quantities of molecular data across a spatial domain are actively being measured and reserved (most commonly stored inside of digital media) for later analyses. While incomplete, this partially known information can be processed (most commonly on/with a computational system) to 1) produce reconstructions for information not acquired, 2) indicate as-of-yet unmeasured locations that probabilistically correlate with desirable information, 3) rank/weight mass-per-charge (m/z) channels according to how probabilistically they correlate with desirable information, and 4) stop an acquisition process when a sufficient quantity of information has been acquired.

The present disclosure is directed to an example implementation, hereafter referred to as a Deep Learning Approach for Dynamic Sparse Sampling (DLADS) algorithm (itself not limited to integration with MSI), which improves throughput of MSI technologies using dynamic sampling.

Specifically, during an active MSI acquisition, DLADS iteratively directs sampling among as-of-yet unmeasured locations to maximize information gain (generally molecularly informative locations) and minimize the number of required measurements to obtain and/or reconstruct desired information with high fidelity. The direction mechanism used in DLADS is a pretrained machine learning model, more specifically a Convolutional Neural Network (CNN), trained in advance of experimental integration with a set of fully-acquired samples (both in spatially and in terms of m/z spectra), for use with samples undergoing acquisition with MSI technologies.

CNNs are a subset of artificial intelligence, machine learning, and neural network design, using convolution(s) as at least one of their data processing mechanisms. Convolution, as known to a person having ordinary skill in the art, is a mathematical process that operates with two functions (e.g., f and g), to produce a third function. The output informs how one function is modified by the other. CNNs were originally inspired by the animal/human visual cortexes, whereby fields within a visual cortex, that receive light in the form of any image, impact different neurons that are partially overlapped, allowing greater visual coverage. CNNs are most typically utilized to process image data, containing spatial distributions of information in pixels.

CNNs commonly include an input layer, one or more hidden layers, and an output layer. The hidden layers have inputs and outputs and may express or encapsulate convolutions or convolutional processes.

The CNN model generates Estimated Reduction in Distortion (ERD) values for as-of-yet unmeasured locations. Each ERD value is an approximated quantification of total remaining entropy relative to the desired information. For the example implementation this may be qualified as how molecularly informative different spatial locations may be in regard to the reconstruction process of visualized m/z channels.

The DLADS algorithm was developed from a Supervised Learning Approach for Dynamic Sampling (SLADS), the most common implementations of which employed either least-squares regression, or Multi-Layer Perceptron (MLP) neural networks to dynamically determine sampling locations for a range of imaging technologies, including electronic microscopy, X-ray diffraction mapping, and Raman spectroscopy.

Compared to SLADS, the DLADS CNN better utilizes corollary spatial and value relationships for determination of future sampling locations.

Ideally, the selection of subsequent measurement locations should take place in real-time, that is to say the amount of time it would take to scan the entirety of a sample would not be increased by the use of the dynamic sampling algorithm. As discussed above, the large amount of data produced from high-quality MSI, makes it prohibitively difficult with current prior art technologies to enable digital file reading, data processing, and dynamic selection of future selection of measurement locations without adding prohibitively costly temporal overhead to existing MSI acquisition processes. Therefore, certain approximations and limits are used in DLADS to obtain a realizable implementation of the described dynamic sampling algorithm in near real-time (i.e., a minimal quantity of temporal overhead as may be judged reasonable to obtain desired information when performing MSI).

Specific to realizable implementations of MSI dynamic sampling described in the present disclosure, the desirable information targeted is a set of m/z channels, a subset of the complete m/z spectra being acquired in an MSI experiment, that are representative of major biological/chemical structures within an experimental sample. This targeted m/z set may be 1) known a priori, as may be determined by expert knowledge or a separate algorithm, 2) determined by a separate algorithm applied to fully-acquired data during the training phase of the DLADS process, further discussed below, and/or 3) determined by a separate algorithm during an active implementation, either based on initial measurement(s), or adjusted over the course of an acquisition.

An MSI experiment may be terminated prior to complete spatial acquisition to improve throughput by 1) expert determination that the measured data, or reconstructions (if generated) are sufficient, or 2) by the dynamic sampling algorithm's determination that scanning additional locations will not add desirable information in great excess of what has already been obtained.

An experimental evaluation was made of a DLADS implementation on a commercial mass spectrometer, with a nanoscale Desorption Electrospray Ionization, (nano-DESI) MSI platform and imaging a mouse kidney tissue. DLADS provided a 2.3-fold improvement in throughput, while generating high-quality reconstructed molecular images.

The present disclosure is divided into two main parts: 1) training of the machine learning model for ERD generation and 2) applying the trained machine learning model to a MSI platform, thus collecting data in a dynamic sparse sampling process. Sparse measurements are used to generate a spatial map of most informative locations and thereby where the MSI system should next measure. The combination of a MSI system and a model, previously trained on fully-acquired data to actively determine future measurement locations based on partial data obtained during an acquisition, can be formed with any machine learning topology. The CNN model topology used for the DLADS implementation example included in the present disclosure is specific to embodiments of utilized training data and intended acquisition targets. Therefore, other embodiments of training, acquisition objectives, and machine learning model formation intended for application of a dynamic sampling process with MSI technologies is within the scope of the present disclosure.

### Training

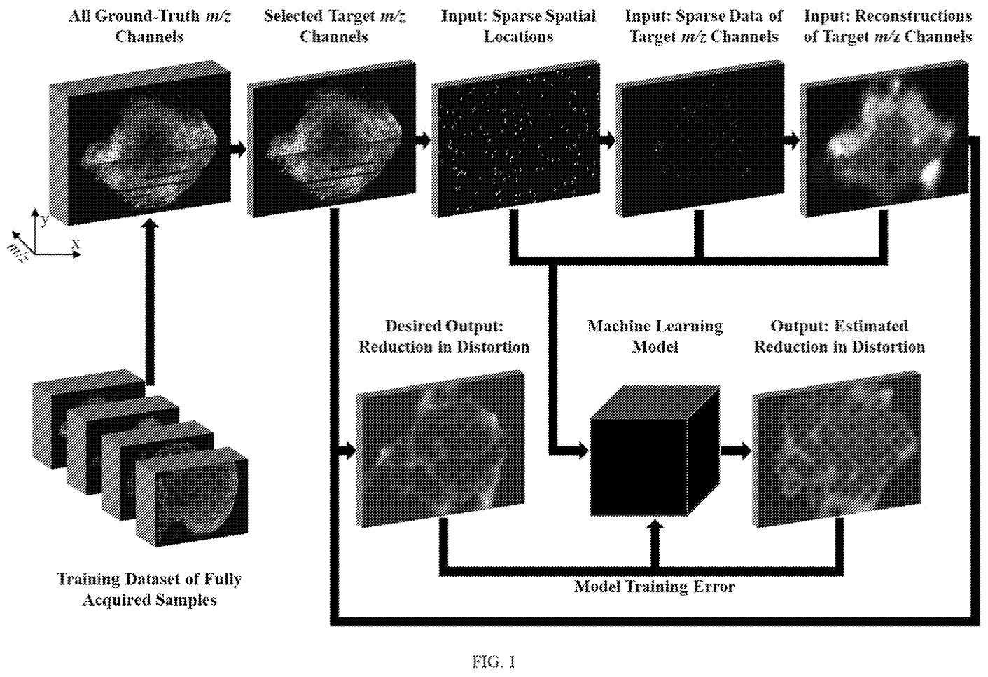

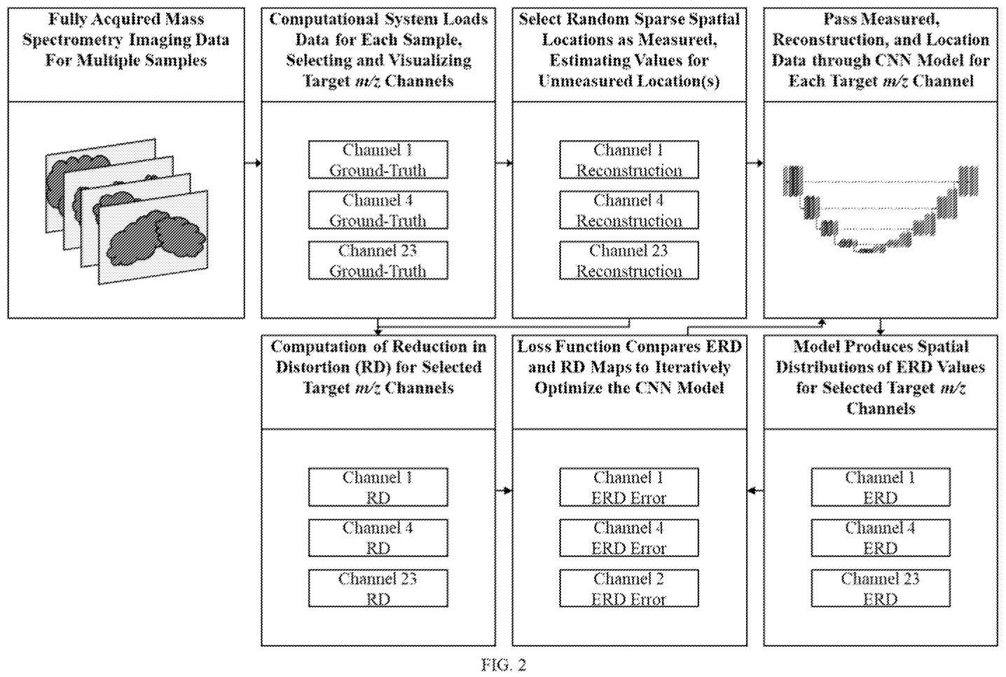

Referring to FIG. 1 and FIG. 2, diagrams are provided which outline the training procedure for DLADS, which serves as one embodiment of the present disclosure. A set of complete MSI samples (i.e. fully acquired reference data), sampled a priori, constitutes a training dataset. Each of these samples contain a plurality of spectra for all measured spatial locations, where each spectrum defines measured intensities across a range of m/z values. For any given m/z value, which corresponds to a particular type(s) of ions/molecules/atoms, the intensities may be mapped into an array, forming a visualizable m/z image channel. Visualized spatial maps of all acquired m/z channel data, across the complete measurable spatial domain. constitutes all ground-truth m/z channels for a sample.

A selection mechanism, and/or a predetermined set may be applied/extracted to reduce the all ground-truth m/z channels to a subset of selected target m/z channels, to emphasize desired information content (e.g., perhaps out of 30 possible channels, only channels 1, 4, and 23 contain data relevant to the desired information), and/or reduce computational requirements (e.g., should a computational system lack capability to process 1,000 m/z channels, as might be acquired in a full spectrum, the set being utilized could be reduced to 10 m/z channels to enable the algorithm's employment). Although done for the example embodiment of the presented disclosure, the selection of target m/z channels does not need to remain consistent among samples, throughout any part of the model training phase, or with regard to the operational phase.

It is known to a person having ordinary skill in the art that the machine learning model being trained should be provided with similar quantities and variation in provided information, as might be encountered in actual operation, discussed below. Sparse spatial locations are determined, either randomly or according to alternative criteria, with known sparse target m/z channel information extracted, accordingly. As an example, for improved elucidation of the selection operation, and not for limitation of the disclosure, the determination of these spatial locations, aside from random selection, may be provided by an expert predetermined set, pattern, the sample gradient, geometry, values, etc. Other statistical approaches to sparse sampling of the fully acquired a priori MSI data are also within the ambit of the present disclosure. For example, location weighting based on richness of data associated with various geometric points of the reference tissue may be chosen, as may be determined through additional pre-processing of the fully acquired a priori MSI data, to provide more meaningful information from the sparse sampling. Furthermore, the sparse sampling methodology and/or specifics used during training may not match with those in operation, discussed further below.

Given spatially sparse information for the target m/z channels, values for unmeasured locations can be estimated. These estimated values can be combined with the known sparse information to form target m/z channel reconstructions. Different approaches may be applied to perform estimates for unmeasured locations and to obtain reconstructions of target m/z channels. For example, according to one embodiment, the image reconstruction may be based on Inverse Distance Weighted (IDW) mean interpolation. However, there are a vast number of different approaches to estimate missing data for m/z channel visualizations from a sparse set of known information. Other approaches for image reconstruction broadly may be defined as either interpolation or inpainting, with classic (non-learning) and learning-based variations. Classic examples include: fast marching, nearest neighbor, linear, bilinear, cubic convolution, kriging, radial basis, IDW, and other classic (non-learning based) topologies, all of which are known to a person having ordinary skill in the art. Learning-based topologies include: Convolutional Neural Networks (CNNs), Generative Adversarial Networks (GANs), graph neural networks, and other learning-based topologies known to a person having ordinary skill in the art. It should be noted that whatever reconstruction topology is used in the training, alternatives may be used during the operational phase according to the present disclosure.

For the example embodiment of the present disclosure, the CNN machine learning model, is iteratively trained, with different sets of inputs and expected outputs, as derived from/for different target m/z channels and/or ground-truth samples from a training dataset of a priori acquired MSI samples. An example training iteration for the example embodiment is hereafter described. For each target m/z channel, a set of sparse spatial locations, corresponding sparse target m/z channel information, and corresponding target m/z channel reconstruction data are input into a CNN machine learning model. The model produces an Estimated Reduction in Distortion (ERD) map. Alternative embodiments of the present disclosure may use different combinations of inputs to obtain single or multiple spatial maps which optimize the relative value offered at potential sampling locations. Several examples include: passing the information of, or derived from, multiple m/z target channels through the model, using information from additional modalities (e.g., optical, fluorescent, prior MSI measurements, etc.), producing fewer/more ERD maps to simultaneously incorporate, or extrapolate from, multiple m/z channels, etc.

The ERD maps are, in the example embodiment of the present disclosure, compared against the desired model outputs: ground-truth Reduction in Distortion (RD) maps; though this is not intended to limit the disclosure from embodiments which train models for dynamic sampling in MSI without ground-truth RD maps. For the example embodiment, the difference, and derivations thereof, between the actual and expected model outputs constitutes an error signal, as computed by a loss function. Minimization of the produced error signals progressively optimizes and converges model behavior(s) towards the production of ERD maps closer to the intended RD maps for any given set of model inputs. Mean Absolute Error (MAE) and/or Mean-Squared Error (MSE) are common examples of machine learning loss functions as discussed above. The minimization of the error signal is conducted using optimizers, with examples including: Adam, Nadam, Root Mean Squared (RMS) Propagation, Stochastic Gradient Descent (SGD), AdaGrad, and other such optimizations topologies, known to a person having ordinary skill in the art. For the example embodiment, the model has been prepared by optimization for use during the operational phase of the dynamic sampling process. Additional manipulations of the trained model (e.g., pruning, validation, regularization, re-training, etc.) before implementation are within the present disclosure scope.

For each unmeasured spatial location in a sample, the Reduction in Distortion (RD) value quantifies how much a reconstruction could be improved by measuring that location. RD maps comprise a spatial distribution of RD values for all locations that have not been directly measured. Although the example embodiment of the present disclosure does not do so, singular RD maps can be explicitly formulated to account for multiple m/z channels and/or reconstruction methods. Within the example embodiment of the present disclosure, with no limitation of such intended, the computation process for RD is now provided. Given a single m/z channel, there exists the complete ground-truth m/z data (acquired a priori): X, a reconstruction formed with a sparse set of known information from that m/z channel: A, and a reconstruction formed with the same sparse set of known information with one additional location measured: B. The RD value for the location of that one additional measurement is equal to the sum absolute difference of the absolute difference of X and A, and the absolute difference of X and B.

However, performing a reconstruction with and without an additional measurement for each and every unmeasured location for a multitude of sparse spatial location sets is computationally costly. Therefore, in the example embodiment of the present disclosure, the RD map is approximated, with the RD value for each unmeasured location equal to the sum of a Gaussian filter (although other statistical filters may also be utilized, as known to a person having ordinary skill in the art), as applied to the difference between a full m/z channel visualization and a reconstruction generated only from partially known information.

### Operation

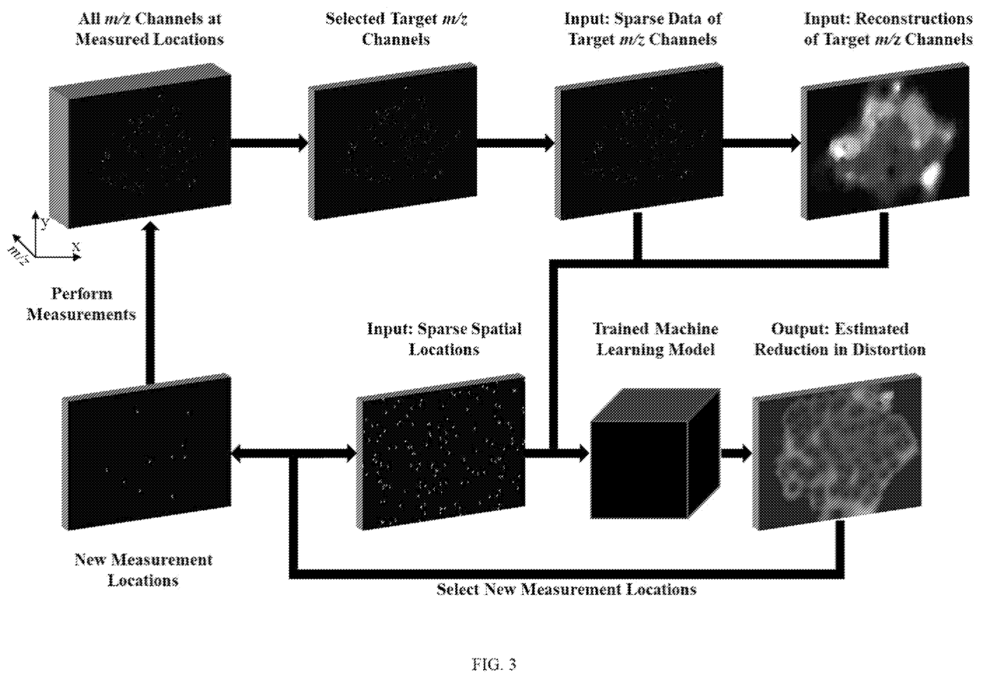

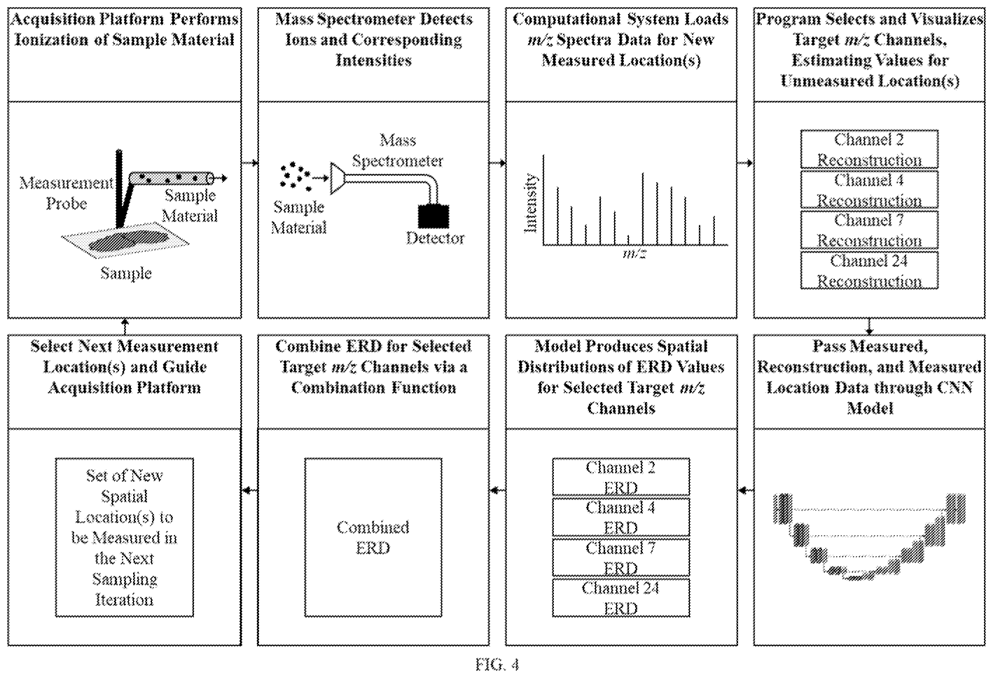

Once the machine learning model has been trained, then according to example embodiment, where the operational phase is illustrated in FIG. 3 and FIG. 4, the CNN may be used to compute an ERD map for each targeted m/z channel, without complete knowledge of the sample.

For the example embodiment of the present disclosure, with no limitation of such intended, the selection of target m/z channels follows the procedures outlined in the prior training section. Thus, if channels 1, 4, and 23 were selected and used for training, then channels 2, 4, 7, and 24 could be selected in the operational phase. Similarly, selected target m/z channels do not need to remain consistent during the operational phase and may be dynamically changed, as new data may identify m/z channels which better correspond to desired information.

An optional initial measurement selection, used for the example embodiment of the present disclosure, but not necessarily required for other variations, seeds the model with some partial knowledge of the actual target sample content through random sparse sampling. The sparse sampling topology, as discussed above may be based on a number of different approaches, including random, quasi-weighted random, structured, etc., which does not need to be the same as the sparse sampling topology used during the training phase.

Sparse target m/z channel information may, again in the operation phase, be used to generate image reconstructions using various image reconstruction topologies, as discussed above, e.g., interpolation, to generate a full image for each target m/z channel.

Dynamic selection of new spatial measurement locations can use one or more of the model-produced per-channel ERD maps, on their own, or in combination with information from additional modalities (e.g., optical, fluorescent, prior MSI measurements, etc.). The ERD maps and potential additional information may be partially or fully merged together into a singular spatial map for new measurement location determination, via a combination function. The combination function may be varied according to the specific embodiment, with the presented example using a weighted average of selected target channel ERD maps (one per-m/z) to provide a single global ERD map, with consideration for the specific purpose of the operational aspect (as desired information goals can vary). This singular global ERD map estimates optimal spatial positions to measure during active acquisition of a sample to maximize desired information gain (for the example embodiment presented, this is the target m/z channel reconstruction quality relative to their ground-truth m/z channel counterparts, though other desired information may be sought after, specified, and utilized in alternative embodiments).

Those having ordinary skill in the art will recognize that numerous modifications can be made to the specific implementations described above. The implementations should not be limited to the particulars described. Other implementations may be possible.

1. A method of determining the next location for obtaining Mass Spectrometry Imaging (MSI) data from a sample using sparse data for a plurality of m/z channels, comprising:
receiving a priori MSI data for a plurality of m/z channels from all of a sample based on a predefined spatial resolution, each m/z channel corresponding to one or more predetermined chemical constituents in the sample;
choosing a first selection of m/z channels of interest from the plurality of m/z channels;
iteratively receiving Estimated Reduction in Distortion (ERD) maps (OPERATIONAL ERDᵢ) from a model for each of the first selection of m/z channels, indicating the next location where the MSI data is to be collected;
identifying a plurality of operational sparse spatial locations on the sample (OPERATIONAL SPARSE SPATIAL LOCATIONS) based on the OPERATIONAL ERDᵢ;
obtaining from the a priori MSI data, data associated with the first selection of m/z channels of interest for each of the OPERATIONAL SPARSE SPATIAL LOCATIONS (OPERATIONAL SPATIALLY SPARSE DATA FOR SELECTED M/Z CHANNELS);
reconstructing an operational MSI image from the spatially sparse data for selected m/z channels representing an operational reconstructed image from all of the sample; and
providing to the model i) the OPERATIONAL SPARSE SPATIAL LOCATIONS ii) the OPERATIONAL SPATIALLY SPARSE DATA FOR SELECTED M/Z CHANNELS, and ii) the reconstructed operational MSI image, the model configured to output ERD maps for each of the first selection of m/z channels, representing the next location where the MSI data is to be collected (OPERATIONAL ERDᵢ₊₁).

2. The method of claim 1, wherein the step of identifying a plurality of operational sparse spatial locations is based on a first sparse location selection criterion.

3. The method of claim 2, wherein the first sparse location selection criterion is based on a random selection.

4. The method of claim 2, wherein the first sparse location selection criterion is based on a statistical selection criterion selected from the group consisting of weighted sampling based on richness of data associated with various geometric points of the sample, non-weighted sampling, a preselected pattern of sampling, or a combination thereof.

5. The method of claim 1, wherein the step of reconstructing an operational MSI image is based on a first reconstruction approach.

6. The method of claim 5, wherein the first reconstruction approach is based on a first non-learning interpolation approach.

7. The method of claim 6, wherein the first non-learning interpolation approach is selected from the group consisting of fast marching, nearest neighbor, linear, bilinear, cubic convolution, kriging, radial basis, Inverse Distance Weighted (IDW) mean interpolation, or a combination thereof.

8. The method of claim 5, wherein the first reconstruction approach is based on a first learning interpolation approach.

9. The method of claim 8, wherein the first learning interpolation approach is selected from the group consisting of convolutional neural networks, generative adversarial networks, graph neural networks, or a combination thereof.

10. The method of claim 1, wherein the model is a neural network.

11. The method of claim 10, wherein the neural network is a convolutional neural network (CNN), having a plurality of layers including an input layer, one or more hidden layers, and an output layer, the plurality of layers connected to each other via weights,
wherein training of the CNN, comprises:
choosing a second selection of m/z channels of interest from the plurality of m/z channels;
for each of the second selection of m/z channels of interest, iteratively:
parsing the a priori MSI data based on the second selection of m/z channels to obtain SELECTED M/Z MSI DATA;
identifying a plurality of training sparse spatial locations on the sample (TRAINING SPARSE SPATIAL LOCATIONS);
obtaining from the SELECTED M/Z MSI DATA, data associated with the TRAINING SPARSE SPATIAL LOCATIONS (TRAINING SPATIALLY SPARSE DATA FOR SELECTED M/Z CHANNELS);
reconstructing training MSI images from the spatially sparse data for selected m/z channels representing a reconstructed image from all of the sample;
providing to the model i) the TRAINING SPARSE SPATIAL LOCATIONS ii) the TRAINING SPATIALLY SPARSE DATA FOR SELECTED M/Z CHANNELS, and ii) the training reconstructed MSI image, the model configured to output training ERD maps (TRAINING ERDᵢ) for each of the second selection of m/z channels;
iteratively establishing a model training error based on comparing the TRAINING ERDᵢ with an actual Reduction in Distortion (RDᵢ) representing a difference between the reconstructed training MSI image and the a priori MSI data; and
minimizing the model training error by modifying the CNN weights.

12. The method of claim 11, wherein the step of identifying a plurality of training sparse spatial locations is based on a second sparse location selection criterion.

13. The method of claim 12, wherein the second sparse location selection criterion is based on a random selection.

14. The method of claim 12, wherein the second sparse location selection criterion is based on a statistical selection criterion selected from the group consisting of weighted sampling based on richness of data associated with various geometric points of the sample, non-weighted sampling, a preselected pattern of sampling, or a combination thereof.

15. The method of claim 12, wherein the second sparse location selection criterion is same as the first sparse location selection criterion.

16. The method of claim 11, wherein the step of reconstructing a training MSI image is based on a second reconstruction approach.

17. The method of claim 16, wherein the second reconstruction approach is same as the first reconstruction approach.

18. The method of claim 16, wherein the second reconstruction approach is based on a second non-learning interpolation approach.

19. The method of claim 18, wherein the second non-learning interpolation approach is same as the first non-learning interpolation approach.

20. The method of claim 18, wherein the second non-learning interpolation approach is selected from the group consisting of fast marching, nearest neighbor, linear, bilinear, cubic convolution, kriging, radial basis, Inverse Distance Weighted (IDW) mean interpolation, or a combination thereof.

21-25. (canceled)
